(19) United States
(12) Patent Application Publication
(10) Pub. No.: US 2025/0253952 A1
(43) Pub. Date: Aug. 7, 2025

(54) INSERTION/REMOVAL STRUCTURE, INSERTION/REMOVAL METHOD, AND OPTICAL TRANSMISSION APPARATUS

(71) Applicant: NEC Corporation, Tokyo (JP)

(72) Inventor: Takenao YOKOMORI, Tokyo (JP)

(73) Assignee: NEC Corporation, Tokyo (JP)

(21) Appl. No.: 19/027,337

(22) Filed: Jan. 17, 2025

(30) Foreign Application Priority Data
Feb. 2, 2024 (JP) 2024-014787

(51) Int. Cl. H04B 10/40; G02B 6/42

(52) U.S. Cl. CPC H04B 10/40; G02B 6/4278

(57) ABSTRACT

Provided are an insertion/removal structure, an insertion/removal method, and an optical transmission apparatus that make it possible to safely insert/remove an optical transceiver. The insertion/removal structure of the optical transceiver includes: an optical transmission apparatus; an optical transceiver configured to be insertable/removable into/from a port of the optical transmission apparatus; and a cover configured to cover a portion, being exposed from the port, of the optical transceiver inserted into the port, and the cover covering the optical transceiver is detachably fixed to an attachment unit of the optical transmission apparatus by a fixing member.

### INCORPORATION BY REFERENCE

This application is based upon and claims the benefit of priority from Japanese patent application No. 2024-014787, filed on Feb. 2, 2024, the disclosure of which is incorporated herein in its entirety by reference.

### TECHNICAL FIELD

The present disclosure relates to an insertion/removal structure, an insertion/removal method, an optical transmission apparatus, a control method, and a control program.

### BACKGROUND ART

An optical transceiver that transmits and receives optical signals is being used in an optical transmission apparatus. Heretofore, an optical transceiver to be fixed on a substrate of an optical transmission apparatus has been mainly used. In recent years, an optical transceiver being insertable/removable (pluggable) into/from an optical transmission apparatus is becoming popular. For example, Patent Literature 1 describes an optical transceiver capable of hot-swapping. Note that the insertion/removal may include either or both of insertion and removal.

### CITATION LIST

### Patent Literature

[Patent Literature 1] Japanese Unexamined Patent Application Publication No. 2017-092855

### SUMMARY

A related optical transceiver as disclosed in Patent Literature 1 is an optical transceiver capable of hot-swapping. Meanwhile, an optical transceiver that does not support hot-swapping has also been developed. For example, it is desired to safely insert and remove such an optical transceiver that does not support hot-swapping.

In view of the problem described above, an example object of the present disclosure is to provide an insertion/removal structure, an insertion/removal method, an optical transmission apparatus, a control method, and a control program that make it possible to safely insert/remove an optical transceiver.

In a first aspect of the present disclosure, an insertion/removal structure includes: an optical transmission apparatus; an optical transceiver configured to be insertable/removable into/from a port of the optical transmission apparatus; and a cover configured to cover a portion, being exposed from the port, of the optical transceiver inserted into the port, wherein the cover covering the optical transceiver is detachably fixed to an attachment unit of the optical transmission apparatus by a fixing member.

In a second aspect of the present disclosure, an insertion/removal method includes: inserting an insertable/removable optical transceiver into a port of an optical transmission apparatus; covering a portion, being exposed from the port, of the optical transceiver inserted into the port with a cover; and detachably fixing, by a fixing member, the cover covering the optical transceiver to the optical transmission apparatus.

In a third aspect of the present disclosure, an optical transmission apparatus includes: a port into/from which an optical transceiver can be inserted/removed; an attachment unit configured to detachably fix, by a fixing member, a cover covering a portion, being exposed from the port, of an optical transceiver inserted into the port; a detection unit configured to detect that detachment of the fixing member from the attachment unit starts; and a control unit configured to execute necessary processing before removal of the optical transceiver, based on a result of the detection.

In a fourth aspect of the present disclosure, a control method includes: in a case where a cover covering a portion, being exposed from a port of an optical transmission apparatus, of an optical transceiver inserted into the port is detachably fixed to an attachment unit of the optical transmission apparatus by a fixing member, detecting that detachment of the fixing member from the attachment unit starts; and executing necessary processing before removal of the optical transceiver, based on a result of the detection.

In a fifth aspect of the present disclosure, a control program is a control program for causing a computer to execute processing of: in a case where a cover covering a portion, being exposed from a port of an optical transmission apparatus, of an optical transceiver inserted into the port is detachably fixed to an attachment unit of the optical transmission apparatus by a fixing member, detecting that detachment of the fixing member from the attachment unit starts; and executing necessary processing before removal of the optical transceiver, based on a result of the detection.

An example advantage according to the present disclosure is that it is possible to safely insert and remove an optical transceiver.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a schematic top view illustrating a configuration example of a related optical transceiver insertion/removal structure;

FIG. 2 is a schematic top view illustrating a configuration example of the related optical transceiver insertion/removal structure;

FIG. 3 is a sequence diagram illustrating an example of an insertion procedure of the related optical transceiver insertion/removal structure;

FIG. 4 is a sequence diagram illustrating an example of a removal procedure of the related optical transceiver insertion/removal structure;

FIG. 5 is a schematic top view for describing a problem in the related optical transceiver insertion/removal structure;

FIG. 6 is a schematic top view illustrating a configuration example of an optical transceiver insertion/removal structure according to some example embodiments;

FIG. 7 is a configuration diagram illustrating a configuration example of a functional block of an optical transmission apparatus according to some example embodiments;

FIG. 8 is a schematic top view illustrating a configuration example of the optical transceiver insertion/removal structure according to some example embodiments;

FIG. 9 is a schematic top view illustrating a configuration example of the optical transceiver insertion/removal structure according to some example embodiments;

FIG. 10 is a configuration diagram illustrating a configuration example of a screw according to some example embodiments;

FIG. 11 is a configuration diagram illustrating a configuration example of a screw hole according to some example embodiments;

FIG. 12 is a schematic front view illustrating an arrangement example of a lever switch in the optical transceiver insertion/removal structure according to some example embodiments;

FIG. 13 is a schematic front view illustrating an arrangement example of the lever switch in the optical transceiver insertion/removal structure according to some example embodiments;

FIG. 14 is a schematic front view illustrating an arrangement example of the lever switch in the optical transceiver insertion/removal structure according to some example embodiments;

FIG. 15 is a schematic front view illustrating an arrangement example of the lever switch in the optical transceiver insertion/removal structure according to some example embodiments;

FIG. 16 is a schematic front view illustrating an arrangement example of the lever switch in the optical transceiver insertion/removal structure according to some example embodiments;

FIG. 17 is a sequence diagram illustrating an example of an insertion procedure of the optical transceiver insertion/removal structure according to some example embodiments;

FIG. 18 is a time chart illustrating an operation example of the insertion procedure of the optical transceiver insertion/removal structure according to some example embodiments;

FIG. 19 is a schematic top view for describing the insertion procedure of the optical transceiver insertion/removal structure according to some example embodiments;

FIG. 20 is a sequence diagram illustrating an example of a removal procedure of the optical transceiver insertion/removal structure according to some example embodiments;

FIG. 21 is a time chart illustrating an operation example of the removal procedure of the optical transceiver insertion/removal structure according to some example embodiments;

FIG. 22 is a schematic top view for describing the removal procedure of the optical transceiver insertion/removal structure according to some example embodiments;

FIG. 23 is a schematic right side view illustrating a configuration example of a front-surface cover in the optical transceiver insertion/removal structure according to some example embodiments;

FIG. 24 is a schematic right side view illustrating a configuration example of the front-surface cover in the optical transceiver insertion/removal structure according to some example embodiments; and

FIG. 25 is a configuration diagram illustrating a hardware configuration example of a computer according to some example embodiments.

### EXAMPLE EMBODIMENT

Hereinafter, example embodiments are described with reference to the drawings. In the drawings, the same elements are denoted by the same reference numerals, and redundant descriptions are omitted as necessary.

### Study of Related Technology

As common pluggable optical transceivers, for example, digital coherent transceivers of form factors such as a quad small form factor pluggable-double density (QSFP56-DD), an octal small form factor pluggable (OSFP), a QSFP112, and a centum form-factor pluggable 2-digital coherent optic (CFP2-DCO) are known. These optical transceivers can transmit tens to thousands of km at 400 Gbps, for example, and consume about 10 W to 30 W of power. Further, these optical transceivers support hot-swapping.

In recent years, pluggable optical transceivers with higher performance have been developed. As a high-performance pluggable optical transceiver, for example, a digital coherent transceiver capable of transmitting several hundred to over 10,000 km at 1200 Gbps has been developed. The power consumption of such a pluggable optical transceiver is several times that of the CFP2-DCO.

As described above, in optical transceivers developed in recent years, power consumption is increased due to having higher performance, and the circuit for hot-swapping measures is becoming more difficult to be mounted due to the increase in density accompanying miniaturization. Further, accompanying higher performance, a monitoring control communication line between the optical transceiver and an optical transmission apparatus is also required to have a high-speed interface of Gbps rate, such as a peripheral component interconnect express (PCIe) as a typical example. However, such high-speed interface is not completely compatible with hot-swapping, and advance preparation is necessary.

If an optical transceiver incompatible with hot-swapping is being removed, an operating system (OS) is required to unmount the apparatus in advance. Therefore, there may be a case where it is necessary to avoid hot-swapping in the pluggable optical transceiver. The inventors have studied insertion/removal procedures in optical transceivers incompatible with hot-swapping, such as a PCIe apparatus and the like.

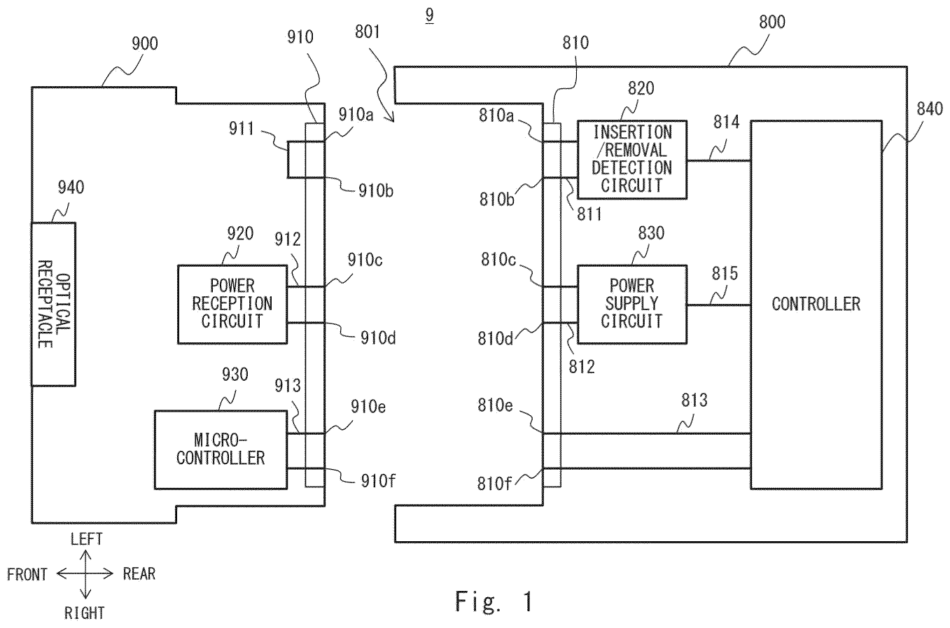

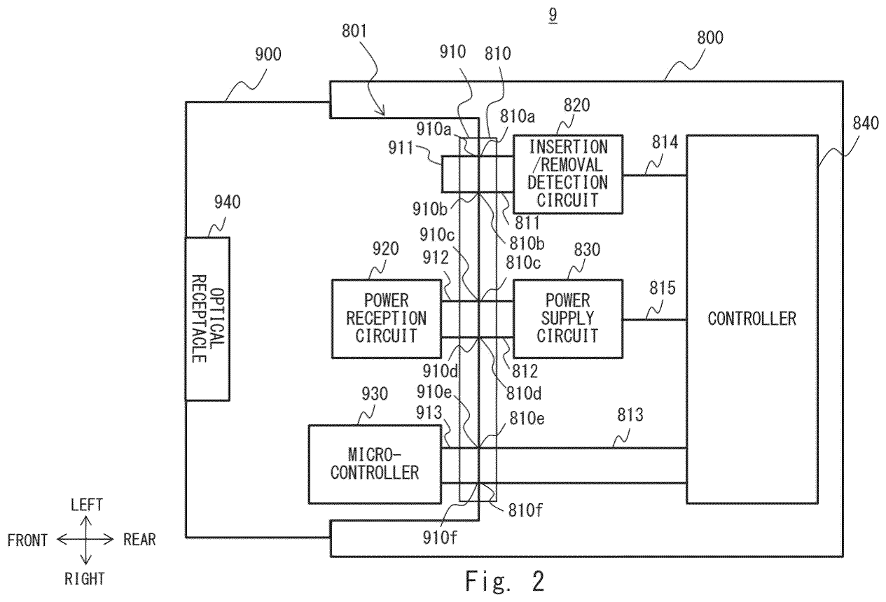

FIGS. 1 and 2 are schematic top views illustrating a configuration example of a related optical transceiver insertion/removal structure 9. FIG. 1 illustrates a state where an optical transceiver 900 is being removed from an optical transmission apparatus 800, and FIG. 2 illustrates a state where the optical transceiver 900 is being inserted into the optical transmission apparatus 800.

As illustrated in FIGS. 1 and 2, in the related optical transceiver insertion/removal structure 9, the optical transceiver 900 can be inserted/removed into/from a port 801 of the optical transmission apparatus 800. As illustrated in FIGS. 1 and 2, the optical transmission apparatus 800 includes the port 801, a terminal unit 810, an insertion/removal detection circuit 820, a power supply circuit 830, and a controller 840. The port 801 is a port for inserting the optical transceiver 900.

The terminal unit 810 is a connector including a plurality of terminals electrically connected to each terminal of the optical transceiver 900. The terminal unit 810 is disposed at a bottom portion of an insertion hole of the port 801. The terminal unit 810 includes terminals 810a and 810b for an insertion/removal detection line 811, terminals 810c and 810d for a power supply line 812, and terminals 810e and 810f for a monitoring control communication line 813.

The insertion/removal detection circuit 820 detects an insertion/removal state of the optical transceiver 900. The insertion/removal detection circuit 820 is connected to the terminals 810a and 810b via the insertion/removal detection line 811. The insertion/removal detection circuit 820 detects the insertion/removal state of the optical transceiver 900 via the insertion/removal detection line 811. The insertion/removal detection circuit 820 is connected to the controller 840 via a detection line 814. The insertion/removal detection circuit 820 notifies the controller 840 of a detection result of the insertion/removal state of the optical transceiver 900 via the detection line 814.

The power supply circuit 830 supplies power to the optical transceiver 900. The power supply circuit 830 is connected to the controller 840 via a control line 815. The power supply circuit 830 receives an instruction to start or stop power supply from the controller 840 via the control line 815. The power supply circuit 830 is connected to the terminals 810c and 810d via the power supply line 812. In response to the instruction to start or stop power supply being input, the power supply circuit 830 starts or stops power supply to the optical transceiver 900 via the power supply line 812.

The controller 840 controls the operation of each unit of the optical transmission apparatus 800. The controller 840 is connected to the insertion/removal detection circuit 820 via the detection line 814, is connected to the power supply circuit 830 via the control line 815, and is connected to the terminals 810e and 810f via the monitoring control communication line 813. The controller 840 receives the detection result of the insertion/removal state of the optical transceiver 900 from the insertion/removal detection circuit 820 via the detection line 814, and receives an instruction from the user as necessary. In response to the input, the controller 840 performs mounting/unmounting of the optical transceiver 900, instruction to the power supply circuit 830 to start or stop power supply via the control line 815, communication with the optical transceiver 900 via the monitoring control communication line 813, and the like.

As illustrated in FIGS. 1 and 2, the optical transceiver 900 includes a terminal unit 910, a power reception circuit 920, a microcontroller 930, and an optical receptacle 940. The optical receptacle 940 is a connector terminal for connecting a connector of an optical fiber.

The terminal unit 910 is a connector including a plurality of terminals electrically connected to each of the terminals of the optical transmission apparatus 800. The terminal unit 910 is disposed on a side opposite to the optical receptacle 940. Note that, in the optical transceiver 900, a side on which the optical receptacle 940 is disposed may be referred to as a front side, and a side on which the terminal unit 910 is disposed may be referred to as a rear side. Further, in the optical transceiver 900, both sides in a direction orthogonal to the front-rear direction may be referred to as a left side and a right side.

The terminal unit 910 includes terminals 910a and 910b for an insertion/removal detection line 911, terminals 910c and 910d for a power supply line 912, and terminals 910e and 910f for a monitoring control communication line 913. The insertion/removal detection line 911 folds back and connects between the terminal 910a and the terminal 910b.

The power reception circuit 920 supplies power supplied from the optical transmission apparatus 800 to each unit of the optical transceiver 900. The power reception circuit 920 is connected to the terminals 910c and 910d via the power supply line 912. The power reception circuit 920 is supplied with power from the optical transmission apparatus 800 via the power supply line 912.

The microcontroller 930 controls the operation of each unit of the optical transceiver 900. The microcontroller 930 is connected to the terminals 910e and 910f via the monitoring control communication line 913. The microcontroller 930 performs, for example, communication with the optical transmission apparatus 800 via the monitoring control communication line 913.

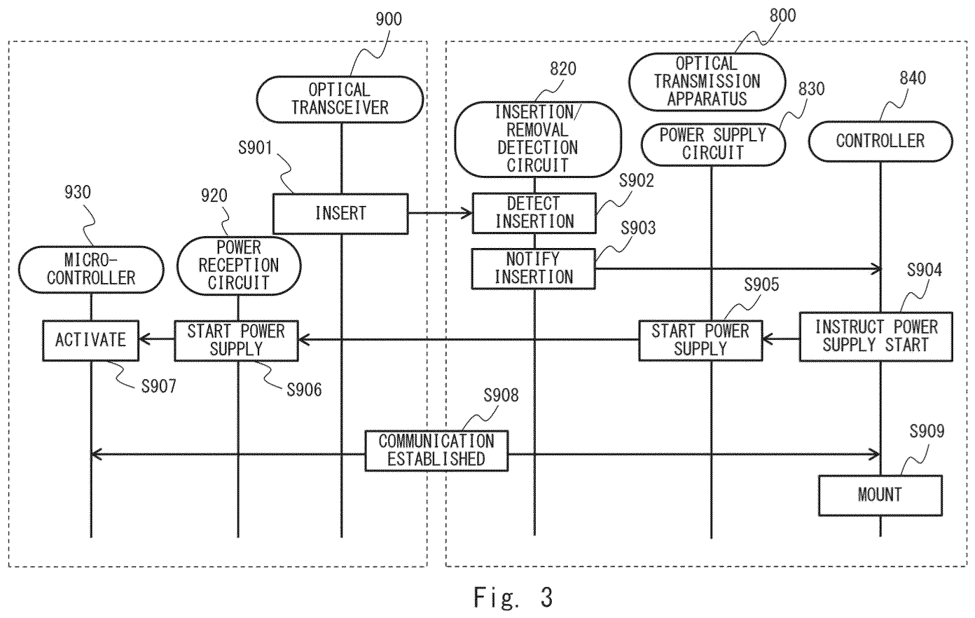

FIG. 3 illustrates an example of an insertion procedure of the related optical transceiver insertion/removal structure 9. The insertion procedure of FIG. 3 is described with reference to FIGS. 1 and 2.

First, in a state where the optical transceiver 900 is removed as illustrated in FIG. 1, a user inserts the optical transceiver 900 into the port 801 of the optical transmission apparatus 800 (S901). As a result, the optical transceiver 900 is inserted as illustrated in FIG. 2. The terminal unit 810 and the terminal unit 910 are connected, and the terminals are electrically connected to each other.

Then, since the insertion/removal detection lines 811 and 911 are short- circuited, the insertion/removal detection circuit 820 of the optical transmission apparatus 800 detects the insertion of the optical transceiver 900 (S902), and notifies the controller 840 of the detection of the insertion (S903). In a case where the insertion detection is notified from the insertion/removal detection circuit 820, the controller 840 instructs the power supply circuit 830 to start power supply (S904). In response to the instruction from the controller 840, the power supply circuit 830 starts power supply to the optical transceiver 900 (S905).

Subsequently, in a case where power source is supplied from the optical transmission apparatus 800, the power reception circuit 920 of the optical transceiver 900 starts power supply to the microcontroller 930 or the like (S906). The microcontroller 930 activates autonomously in a case where power source is supplied from the power reception circuit 920 (S907). Thereafter, the controller 840 attempts to communicate with the microcontroller 930, and communication is established (S908). In a case where communication with the microcontroller 930 is established, the controller 840 mounts the optical transceiver 900 on the OS (S909). In addition, the controller 840 initiates monitoring control with the microcontroller 930.

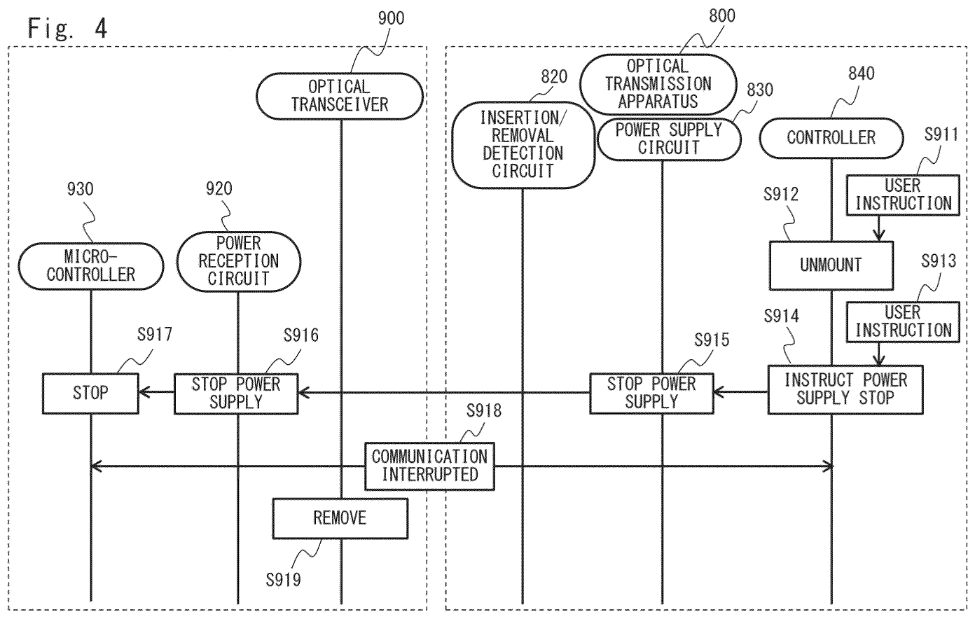

FIG. 4 illustrates an example of a removal procedure of the related optical transceiver insertion/removal structure 9. The removal procedure of FIG. 4 is described with reference to FIGS. 1 and 2.

First, in a case where the optical transceiver 900 is to be removed from a state where the optical transceiver 900 is inserted as illustrated in FIG. 2, necessary processing is performed before the removal. Specifically, as illustrated in FIG. 4, the user instructs the controller 840 of the optical transmission apparatus 800 to unmount (S911), and the controller 840 unmounts the optical transceiver 900 from the OS in response to the instruction from the user (S912).

Subsequently, the user instructs the controller 840 to stop power supply (S913), and the controller 840 instructs the power supply circuit 830 to stop power supply in response to the instruction from the user (S914). In response to the instruction from the controller 840, the power supply circuit 830 stops the power supply to the optical transceiver 900 (S915).

Subsequently, in a case where the power supply from the optical transmission apparatus 800 is stopped, the power reception circuit 920 of the optical transceiver 900 stops the power supply to the microcontroller 930 or the like (S916). In a case where the power supply from the power reception circuit 920 is stopped, the microcontroller 930 stops the operation (S917). In a case where the optical transceiver 900 is removed before the power supply is stopped, there is a possibility that the power reception circuit 920 and preceding components are electrically damaged.

Thereafter, communication between the controller 840 and the microcontroller 930 is interrupted (S918). Subsequently, the user removes the optical transceiver 900 from the port 801 of the optical transmission apparatus 800 (S919). As a result, the optical transceiver 900 is removed as illustrated in FIG. 1. In a case where communication is interrupted before unmounting, the OS may stop. In addition, in a case where the optical transceiver 900 is removed during communication, there is a possibility that the control line terminals of the controller 840 and the microcontroller 930 may be electrically damaged.

As described above, in the related optical transceiver insertion/removal structure, the user needs to perform advance preparation such as unmounting and power supply stop upon removing the optical transceiver. If the user forgets the advance preparation, failure of the optical transmission apparatus or the optical transceiver may occur due to removal of the optical transceiver.

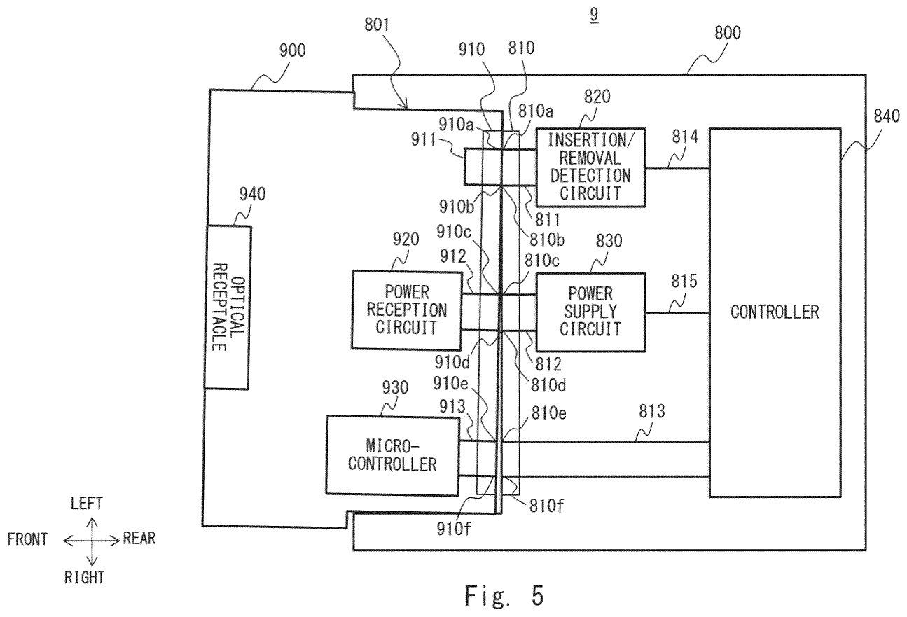

In addition, FIG. 5 illustrates a problem at the time of insertion of the related optical transceiver insertion/removal structure 9. As illustrated in FIG. 5, in the related optical transceiver insertion/removal structure 9, oblique insertion of the optical transceiver 900 with respect to the port 801 (terminal unit 810) may occur. In the present example, the insertion/removal detection line 811 and the insertion/removal detection line 911 are being connected, and between the power supply line 812 and the power supply line 912, and between the monitoring control communication line 813 and the monitoring control communication line 913 are not connected. Therefore, even though the insertion of the optical transceiver 900 is detected, the power supply line and the monitoring control communication line are not connected, which may lead to a malfunction.

### First Example Embodiment

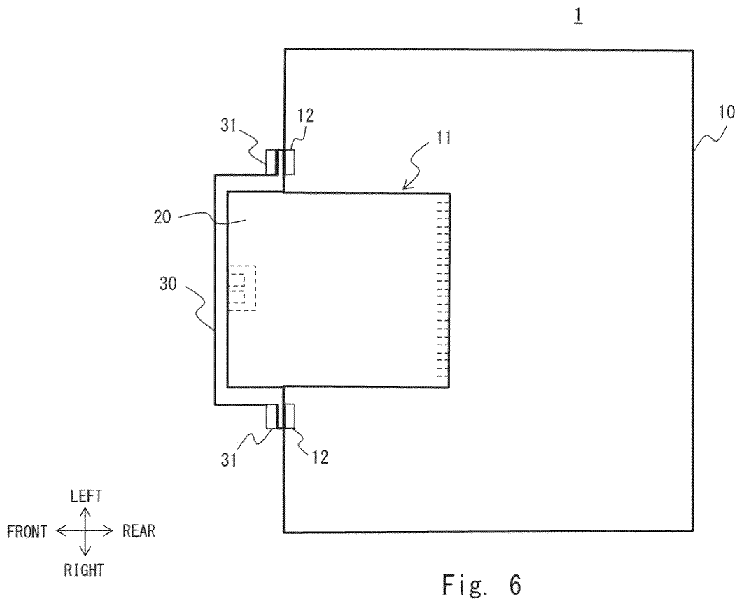

Next, a first example embodiment is described. FIG. 6 is a schematic top view illustrating a configuration example of an optical transceiver insertion/removal structure 1 according to some example embodiments. FIG. 6 illustrates a state where an optical transceiver 20 is being inserted into an optical transmission apparatus 10.

In the example of FIG. 6, the optical transceiver insertion/removal structure 1 includes the optical transmission apparatus 10, the optical transceiver 20, and a cover 30. The optical transmission apparatus 10 is a communication apparatus configured to perform optical communication via an optical fiber connected to the optical transceiver 20. The optical transmission apparatus 10 includes a port 11 and an attachment unit 12. The port 11 is an insertion unit to/from which the optical transceiver 20 is inserted/removed.

The optical transceiver 20 is a pluggable optical transceiver configured to be insertable/removable into/from the port 11 of the optical transmission apparatus 10. For example, the optical transceiver 20 may be a digital coherent transceiver capable of transmitting 400 Gbps, such as QSFP56-DD, OSFP, QSFP 112, CFP2-DCO, or a digital coherent transceiver capable of transmitting 1200 Gbps and having a higher performance. The optical transceiver 20 may be connected to the optical transmission apparatus 10 by PCIe, or may be connected by another interface.

The cover 30 is a cover (front-surface cover) for covering the optical transceiver 20 inserted into the port 11 of the optical transmission apparatus 10. The cover 30 covers the front surface of the optical transceiver 20, i.e., a portion of the inserted optical transceiver 20 exposed from the port 11.

As illustrated in FIG. 6, the optical transceiver 20 inserted into the port 11 of the optical transmission apparatus 10 is covered with a cover 30, and the cover 30 is detachably fixed to the attachment unit 12 of the optical transmission apparatus 10 by a fixing member 31. For example, the fixing member 31 may be a screw, and the attachment unit 12 may be a screw hole into which the screw is inserted.

The cover 30 may be fixed using one fixing member 31, or the cover 30 may be fixed using a plurality of fixing members 31. For example, first and second attachment units 12 may be disposed on the outer peripheral portion of the opening of the port 11. The first attachment unit 12 may be fixed by a first fixing member 31, and the second attachment unit 12 may be fixed by a second fixing member 31. For example, the first and second fixing members 31 may fix the cover 30 on both sides in the left-right direction of the optical transceiver 20. For example, the left-right direction is also a direction in which a plurality of terminals electrically connecting the optical transceiver 20 and the port 11 are arranged.

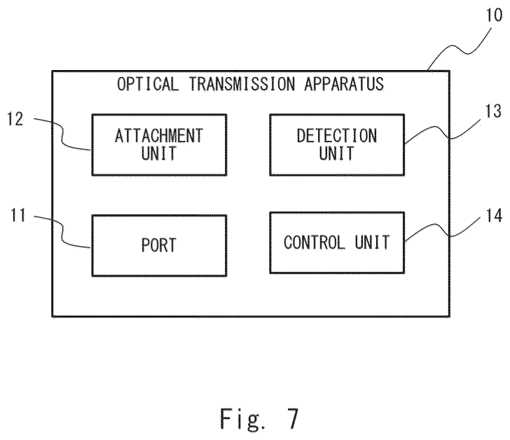

FIG. 7 illustrates a configuration example of a functional block of the optical transmission apparatus 10 according to some example embodiments. In the example of FIG. 7, the optical transmission apparatus 10 includes a detection unit 13 and a control unit 14 in addition to the port 11 and the attachment unit 12 illustrated in FIG. 6.

The detection unit 13 detects an attachment state of the fixing member 31 to the attachment unit 12. The detection unit 13 detects that the fixing member 31 is being detached from the attachment unit 12. Specifically, the detection unit 13 detects that the detachment of the fixing member 31 from the attachment unit 12 has started. The detection unit 13 may detect a period from the detachment of the fixing member 31 from the attachment unit 12 is started until the detachment is completed. In a case where the fixing member 31 can be inserted into the attachment unit 12, the detection portion 13 may detect that the fixing member 31 is in the process of being detached from the attachment unit 12. For example, the detection unit 13 may be a switch that detects the presence or absence of the tip end portion of the screw at the bottom portion of the screw hole.

The control unit 14 executes pre-removal preparation processing (advance preparation processing) for the optical transceiver 20, based on the detection result of the detection unit 13. The pre-removal preparation processing is processing necessary before the optical transceiver 20 is removed. For example, the pre-removal preparation processing includes unmounting the optical transceiver 20, stopping power supply to the optical transceiver 20, and the like.

As described above, in the present example embodiment, the optical transceiver is inserted into the optical transmission apparatus, and the cover covering the inserted optical transceiver is detachably fixed by the fixing member such as a screw. As a result, the optical transceiver can be brought into an appropriately inserted state. For example, by performing fixing by using a plurality of fixing members, it is possible to reliably insert the optical transceiver in such a way as not to malfunction. Further, by fixing the cover covering the optical transceiver by the fixing member, upon removing the optical transceiver, it is necessary to detach the fixing member first. During the time after the fixing member is detached and before the optical transceiver is removed, it is possible to execute the processing necessary before removing the optical transceiver. The optical transmission apparatus detects that the detachment of the fixing member has started, for example, that the fixing member is in the process of being detached, and automatically executes processing necessary before removal according to the detection result, whereby the necessary processing can be reliably executed before the removal. Therefore, the optical transceiver can be safely inserted/removed.

### Second Example Embodiment

Next, a second example embodiment is described. In the present example embodiment, a specific example of the first example embodiment is described.

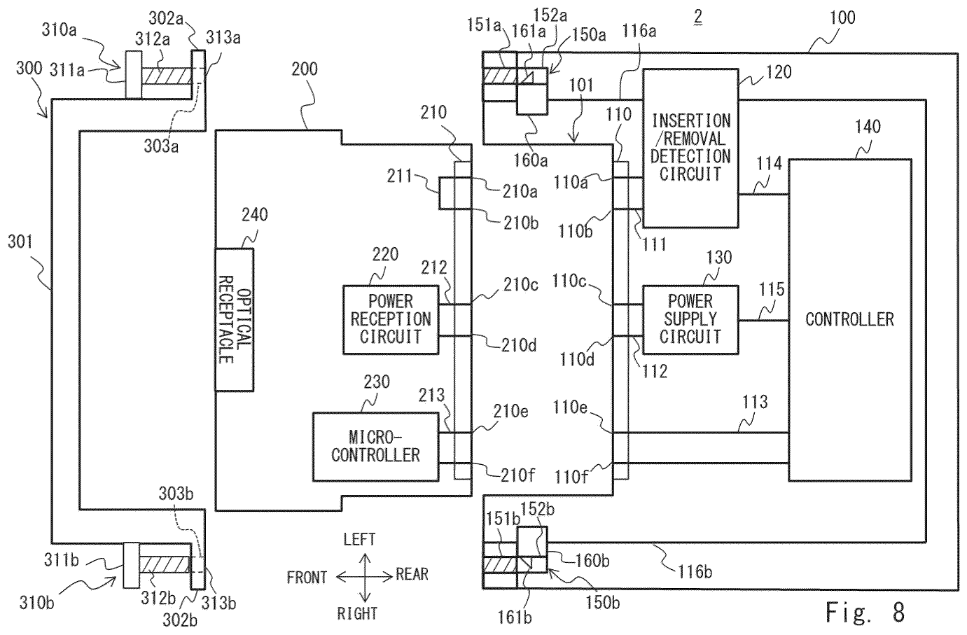

FIGS. 8 and 9 are schematic top views illustrating a configuration example of an optical transceiver insertion/removal structure 2 according to some example embodiments. In the example of FIGS. 8 and 9, the optical transceiver insertion/removal structure 2 includes an optical transmission apparatus 100, an optical transceiver 200, and a front-surface cover 300. FIG. 8 illustrates a state where the optical transceiver 200 is removed and the front-surface cover 300 is detached, and FIG. 9 illustrates a state where the optical transceiver 200 is inserted and the front-surface cover 300 is attached.

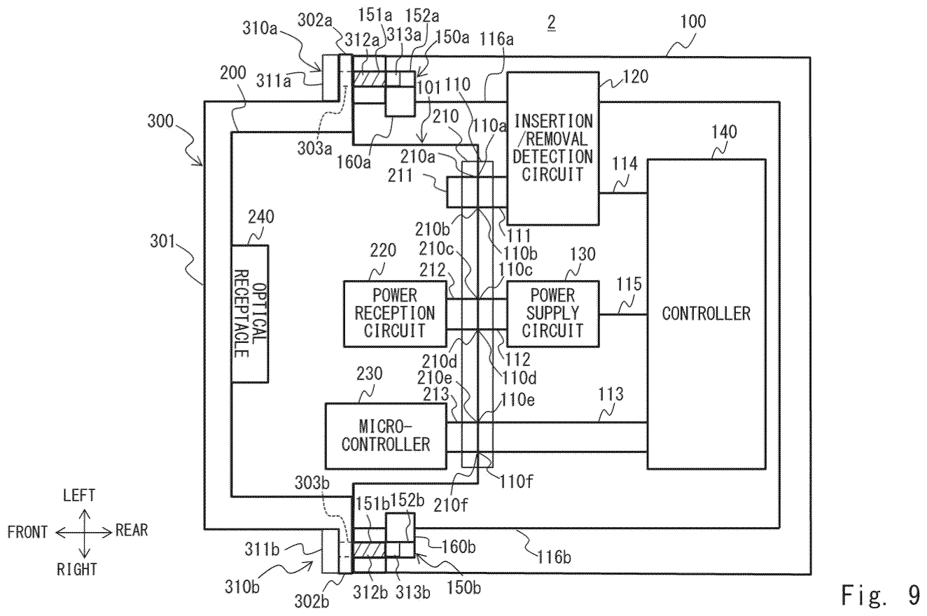

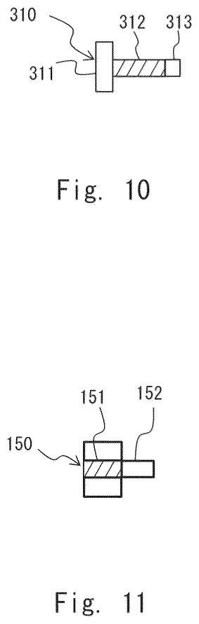

FIG. 10 illustrates a configuration example of a screw 310 for attaching the front-surface cover 300. FIG. 11 illustrates a configuration example of a screw hole 150 of the optical transmission apparatus 100 into which the screw 310 is being inserted. The screw 310 is one example of a fixing member that detachably fixes the front-surface cover 300. The screw hole 150 is one example of an attachment unit with which the front-surface cover 300 is attached by a fixing member. In the example of FIG. 10, the screw 310 includes a head portion 311, a male screw portion 312, and a tip portion 313. The male screw portion 312 is formed with a male screw thread to be screwed (fitted) into a female screw of the screw hole 150. The male screw portion 312 is formed from the head portion 311 of the screw 310 to an intermediate portion of the shaft portion. For example, the length of the male screw portion 312 is associated with the depth of the female screw of the screw hole 150. No thread is formed in the tip portion 313, which is closer to the tip than the male screw portion 312, of the screw 310.

In the example of FIG. 11, the screw hole 150 includes a female screw portion 151 and a bottom portion 152. The female screw portion 151 is formed with a female screw thread to be screwed with the male screw of the screw 310. The female screw portion 151 is formed from a housing surface of the optical transmission apparatus 100 to the middle of the screw hole. No thread is formed in the bottom portion 152 being deeper than the female screw portion 151 of the screw hole 150.

As illustrated in FIGS. 8 and 9, the optical transmission apparatus 100 includes a port 101, a terminal unit 110, an insertion/removal detection circuit 120, a power supply circuit 130, a controller 140, screw holes 150 (150a and 150b), and lever switches 160 (160a and 160b).

The port 101, the terminal unit 110, and the power supply circuit 130 are similar to those in FIGS. 1 and 2. That is, the port 101 is a port for inserting the optical transceiver 200.

The terminal unit 110 is a connector including a plurality of terminals electrically connected to each terminal of the optical transceiver 200. The terminal unit 110 is disposed at the bottom portion of the insertion hole of the port 101. The terminal unit 110 includes terminals 110a and 110b for an insertion/removal detection line 111, terminals 110c and 110d for a power supply line 112, and terminals 110e and 110f for a monitoring control communication line 113.

The power supply circuit 130 supplies power to the optical transceiver 200. The power supply circuit 130 is connected to the controller 140 via a control line 115. The power supply circuit 130 receives an instruction to start or stop power supply from the controller 140 via the control line 115. The power supply circuit 130 is connected to the terminals 110c and 110d via the power supply line 112. The power supply circuit 130 starts or stops power supply to the optical transceiver 200 via the power supply line 112 in response to the input power supply start or power supply stop instruction.

The insertion/removal detection circuit 120 is a detection unit configured to detect the insertion/removal state of the optical transceiver 200 and further detect the attachment/detachment state of the front-surface cover 300. In the present example, the insertion/removal detection circuit 120 detects, as the attachment/removal state of the front-surface cover 300, the insertion/removal state of the screws 310a and 310b for attaching the front-surface cover 300. The insertion/removal detection circuit 120 is connected to the terminals 110a and 110b via the insertion/removal detection line 111. The insertion/removal detection circuit 120 detects the insertion/removal state of the optical transceiver 200 via the insertion/removal detection line 111.

The insertion/removal detection circuit 120 is connected to the lever switches 160a and 160b via lever switch detection lines 116a and 116b. The insertion/removal detection circuit 120 detects on/off of the lever switches 160a and 160b via the lever switch detection lines 116a and 116b. It can be said that the insertion/removal detection circuit 120 and the lever switches 160a and 160b are detection units. The on/off states of the lever switches 160a and 160b indicate the insertion/removal states of the screws 310a and 310b for attaching the front-surface cover 300. That is, the insertion/removal detection circuit 120 detects the insertion/removal state of the screws 310a and 310b by the lever switches 160a and 160b. For example, the insertion/removal detection circuit 120 detects, by the lever switches 160a and 160b, that the removal of the screws 310a and 310b has started, specifically, that the screws 310a and 310b are in the process of being removed.

The insertion/removal detection circuit 120 is connected to the controller 140 via a detection line 114. The insertion/removal detection circuit 120 notifies, via the detection line 114, the controller 140 of the detection result of the insertion/removal state of the optical transceiver 200 and the insertion/removal state of the screws 310a and 310b. For example, in a case where the insertion of the optical transceiver 200 is detected and the insertion of the screws 310a and 310b is also detected, the insertion/removal detection circuit 120 notifies the controller 140 of the detection of the insertion. Note that, the insertion/removal detection circuit 120 may notify all of the detection of the insertion of the optical transceiver 200 and the screws 310a and 310b, and the controller 140 may determine whether all of the insertion has been detected. In addition, the insertion/removal detection circuit 120 notifies the controller 140 of the detection of removal in a case where removal of any one of the optical transceiver 200 and the screws 310a and 310b is detected.

The controller 140 is a control unit configured to control the operation of each unit of the optical transmission apparatus 100. The controller 140 is connected to the insertion/removal detection circuit 120 via the detection line 114, is connected to the power supply circuit 130 via the control line 115, and is connected to the terminals 110e and 110f via the monitoring control communication line 113. The controller 140 receives, via the detection line 114, the detection result of the insertion/removal state of the optical transceiver 200 and the screws 310a and 310b from the insertion/removal detection circuit 120. According to the input detection result of the insertion/removal state of the optical transceiver 200 and the screws 310a and 310b, the controller 140 performs mounting/unmounting of the optical transceiver 200, instruction to start or stop of power supply to the power supply circuit 130 via the control line 115, communication with the optical transceiver 200 via the monitoring control communication line 113, and the like. For example, in a case where insertion of all of the optical transceiver 200 and the screws 310a and 310b is detected, the controller 140 mounts the optical transceiver 200 and instructs the power supply to be started. In a case where removal (including the start of removal and the middle of removal) of any of the optical transceiver 200 and the screws 310a and 310b is detected, the controller 140 unmounts the optical transceiver 200, and instructs the power supply to be stopped.

In the example of FIGS. 8 and 9, the screw holes 150a and 150b are formed on the left and right sides of the port 101. The lever switches 160a and 160b are disposed relative to the screw holes 150a and 150b. The lever switches 160a and 160b detect the screws 310a and 310b that are being inserted into the screw holes 150a and 150b. The lever switches 160a and 160b detect the presence or absence of the screws 310a and 310b in the bottom portions 152a and 152b of the screw holes 150a and 150b. For example, lever switches 160a and 160b include switchable levers 161a and 161b. The levers 161a and 161b are disposed in such a way as to project into the bottom portions 152a and 152b of the screw holes 150a and 150b. The position of the levers 161a and 161b determines the on/off operation point of the lever switches 160a and 160b. The lever switches 160a and 160b are turned on by inserting the screws 310a and 310b into the screw holes 150a and 150b and pressing the levers 161a and 161b by tip portions 313a and 313b of the screws 310a and 310b. The lever switches 160a and 160b are turned off by removing the screws 310a and 310b from the screw holes 150a and 150b and the tip portions 313a and 313b of the screws 310a and 310b being separated from the levers 161a and 161b. The lever switches 160a and 160b output on/off according to insertion/removal of the screws 310a and 310b via the lever switch detection lines 116a and 116b. This makes it possible to detect the insertion/removal states of the screws 310a and 310b. For example, it can be detected that the removal of the screws 310a and 310b has started, specifically, that the screws 310a and 310b are in the process of being removed. The detection timings of the lever switches 160a and 160b can be adjusted by the positions where the levers 161a and 161b are disposed.

Note that, the insertion/removal state of the screw 310 may be detected not only by the lever switch 160 but also by other switches or detection means. Further, the lever switch 160 may be pressed not only by the screw 310 but also by other fixing members. For example, the fixing member is preferably a member that require a certain amount of time to remove the front-surface cover 300, similarly to the screw.

As illustrated in FIGS. 8 and 9, the optical transceiver 200 includes a terminal unit 210, a power reception circuit 220, a microcontroller 230, and an optical receptacle 240. The terminal unit 210, the power reception circuit 220, the microcontroller 230, and the optical receptacle 240 are similar to those in FIGS. 1 and 2. That is, the optical receptacle 240 is a connector terminal configured to connect a connector of an optical fiber.

The terminal unit 210 is a connector including a plurality of terminals electrically connected to each of the terminals of the optical transmission apparatus 100. The terminal unit 210 is disposed on a side opposite to the optical receptacle 240. The terminal unit 210 includes terminals 210a and 210b for an insertion/removal detection line 211, terminals 210c and 210d for a power supply line 212, and terminals 210e and 210f for a monitoring control communication line 213. The insertion/removal detection line 211 folds back and connects between the terminal 210a and the terminal 210b.

The power reception circuit 220 supplies power supplied from the optical transmission apparatus 100 to each unit of the optical transceiver 200. The power reception circuit 220 is connected to the terminals 210c and 210d via the power supply line 212. The power reception circuit 220 is supplied with power from the optical transmission apparatus 100 via the power supply line 212.

The microcontroller 230 controls the operation of each unit of the optical transceiver 200. The microcontroller 230 is connected to the terminals 210e and 210f via the monitoring control communication line 213. The microcontroller 230 performs, for example, communication with the optical transmission apparatus 100 via the monitoring control communication line 213.

The front-surface cover 300 is a cover configured to cover a front surface (a surface on which the optical receptacle is disposed) of the optical transceiver 200 inserted into the port 101. The front-surface cover 300 includes a cover body 301 and fixing portions 302 (302a and 302b).

The cover body 301 has a shape that can cover the front surface of the optical transceiver 200, i.e., a portion being exposed from the port 101 while the optical transceiver 200 is inserted into the port 101. For example, the cover body 301 has a shape relative to the front surface of the optical transceiver 200 and that do not interfere with the optical receptacle 240.

The fixing portions 302a and 302b fix the cover main body 301 to the optical transmission apparatus 100. Through holes 303a and 303b are formed in the fixing portions 302a and 302b. The screws 310a and 310b are passed through the through holes 303a and 303b, and the screws 310a and 310b are inserted into the screw holes 150a and 150b of the optical transmission apparatus 100. The head portions 311a and 311b of the screws 310a and 310b press the fixing portions 302a and 302b to thereby fix the cover main body 301 to the optical transmission apparatus 100.

Note that, the numbers and positions of the lever switch 160 and the screw 310 (the screw hole 150) in FIGS. 8 and 9 are examples, and are not limited thereto. A plurality of lever switches 160 and screws 310 may be further disposed. A plurality of lever switches 160 and screws 310 may be disposed anywhere on the outer circumference of the optical transceiver 200 (port 101). For example, the lever switch 160 and the screw 310 may be disposed at any position on the left and right sides of the optical transceiver 200, or may be disposed at other positions. By disposing on the left and right sides of the optical transceiver 200, oblique insertion of the optical transceiver 200 can be suppressed.

FIGS. 12 to 16 are schematic front views illustrating an arrangement example of the lever switch 160 according to some example embodiments. The position of the lever switch 160 is also the position of the screw 310 (screw hole 150). The position of the optical transceiver 200 is also the position of the port 101. For example, the arrangement examples of FIGS. 12 to 16 may be combined with one another.

In the example of FIG. 12, the two lever switches 160a and 160b are disposed on both left and right sides of the optical transceiver 200, and the positions (heights) thereof in the up-down direction are the same. The lever switches 160a and 160b are disposed in such a way as to face each other in the left-right direction. For example, the lever switches 160a and 160b are disposed at the centers on the left and right sides of the optical transceiver 200. The lever switches 160a and 160b may be disposed above the centers on the left and right sides of the optical transceiver 200, or may be disposed below the centers on the left and right sides of the optical transceiver 200.

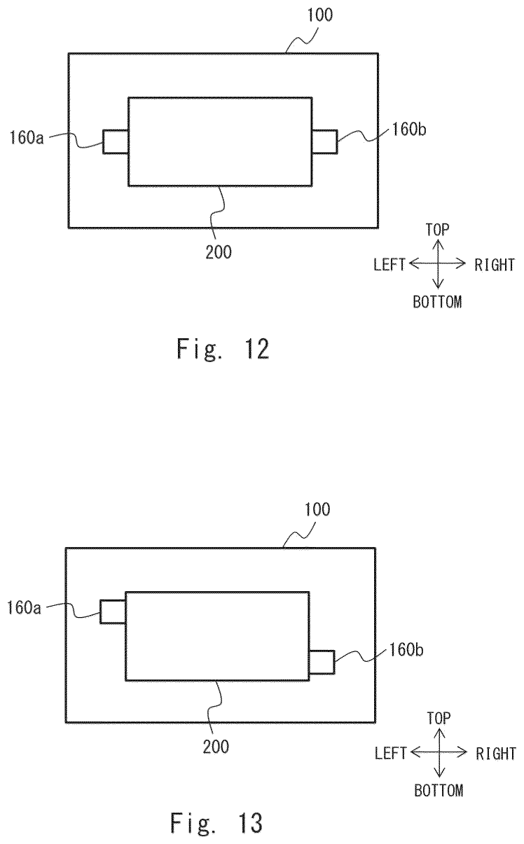

In the example of FIG. 13, the two lever switches 160a and 160b are disposed on both left and right sides of the optical transceiver 200, and the positions (heights) thereof in the up-down direction are different from each other. For example, the lever switch 160a is disposed above the center on the left side of the optical transceiver 200. The lever switch 160b is disposed below the center on the right side of the optical transceiver 200. Note that, the lever switch 160a may be disposed below the center on the left side of the optical transceiver 200, and the lever switch 160b may be disposed above the center on the right side of the optical transceiver 200.

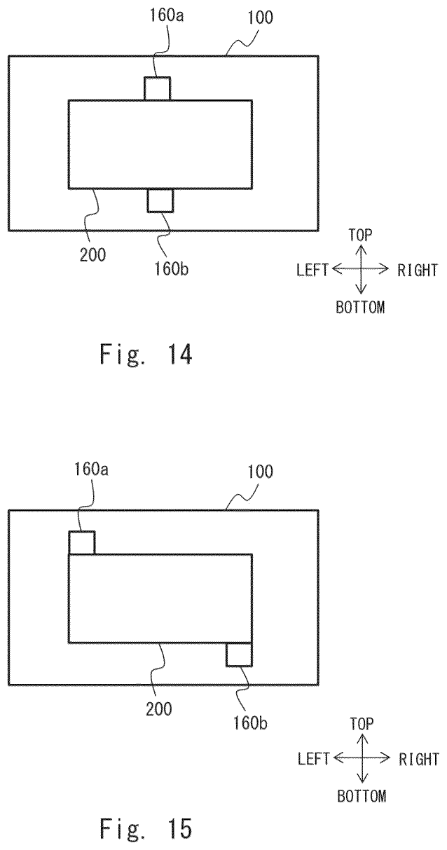

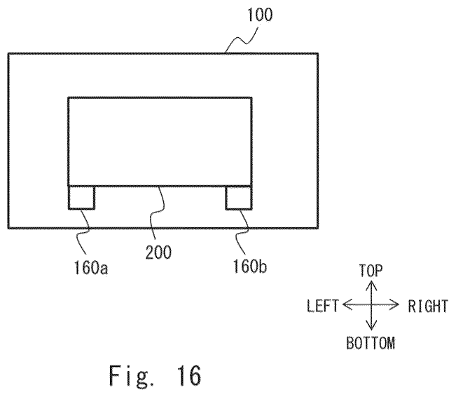

In the example of FIG. 14, the two lever switches 160a and 160b are disposed on both upper and lower sides of the optical transceiver 200, and the positions thereof in the left-right direction are the same. The lever switches 160a and 160b are disposed in such a way as to face each other in the up-down direction. For example, the lever switches 160a and 160b are disposed at the centers on both upper and lower sides of the optical transceiver 200. The lever switches 160a and 160b may be disposed to the right of the centers on both upper and lower sides of the optical transceiver 200, or may be disposed to the left of the centers on both upper and lower sides of the optical transceiver 200.

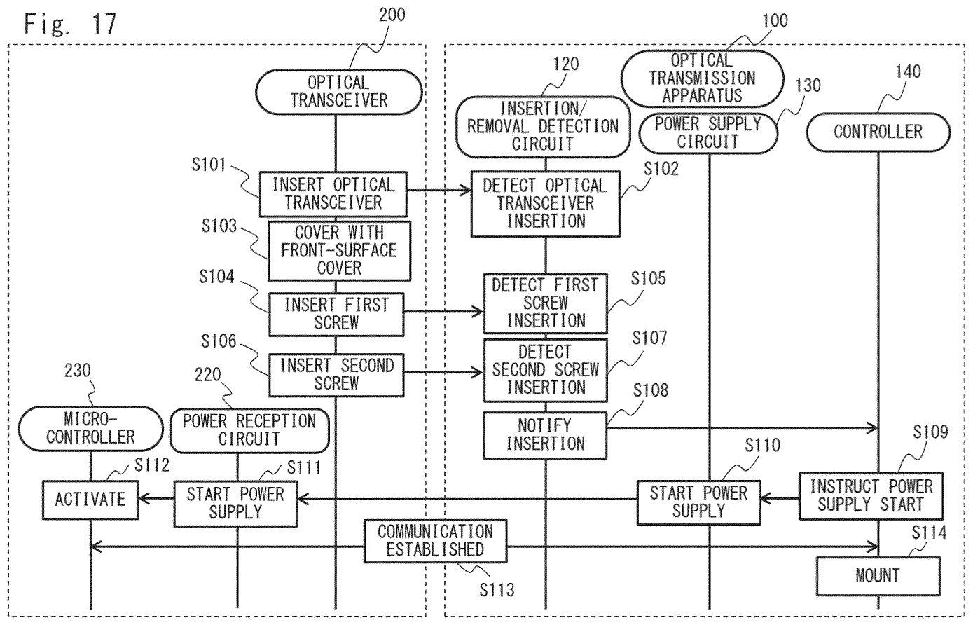

In the example of FIG. 15, the two lever switches 160a and 160b are disposed on both upper and lower sides of the optical transceiver 200 and the positions thereof in the left-right direction are different from each other. For example, the lever switch 160a is disposed at the left end on the upper side of the optical transceiver 200. Such position is not limited to the left end, and the lever switch 160a may be disposed to the left of the center. The lever switch 160b is disposed at the right end on the lower side of the optical transceiver 200. Such position is not limited to the right end, and the lever switch 160b may be disposed to the right of the center. Note that, the lever switch 160a may be disposed at the right end on the upper side of the optical transceiver 200, and the lever switch 160b may be disposed at the left end on the lower side of the optical transceiver 200.

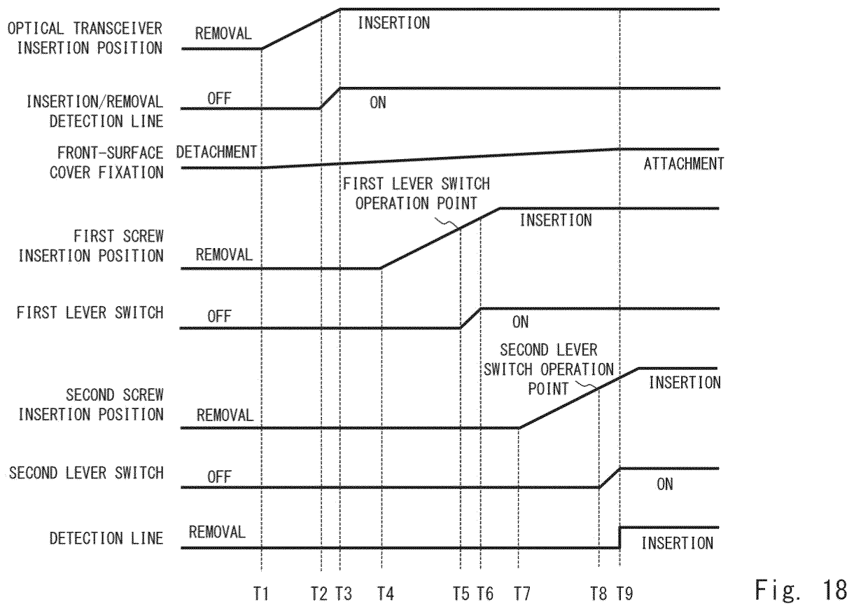

In the example of FIG. 16, the two lever switches 160a and 160b are disposed on the lower side of the optical transceiver 200. For example, the lever switch 160a is disposed at the left end on the lower side of the optical transceiver 200. Such position is not limited to the left end, and the lever switch 160a may be disposed to the left of the center. The lever switch 160b is disposed at the right end on the lower side of the optical transceiver 200. Such position is not limited to the right end, and the lever switch 160b may be disposed to the right of the center. The lever switches 160a and 160b may be disposed on the upper side of the optical transceiver 200. The lever switches 160a and 160b may be disposed on the right or left side of the optical transceiver 200.

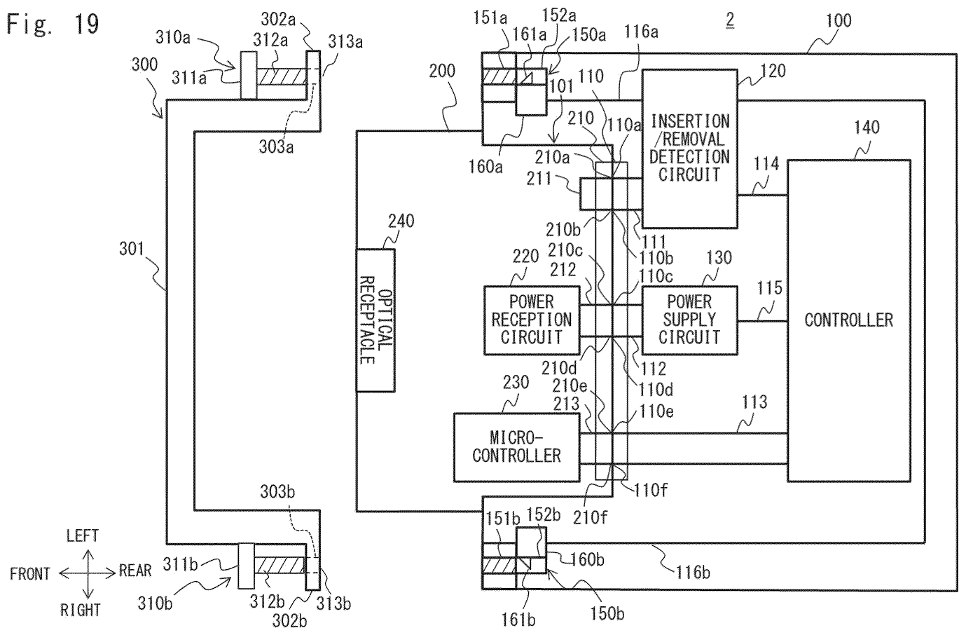

FIG. 17 illustrates an example of an insertion procedure in the optical transceiver insertion/removal structure 2 according to some example embodiments. FIG. 18 is a time chart illustrating an operation example associated with S101 to S107 in FIG. 17. FIG. 19 illustrates a state where the optical transceiver 200 is inserted and the front-surface cover 300 is detached. The insertion procedures of FIGS. 17 and 18 are described with reference to FIGS. 8, 9, and 19.

First, in a state where the optical transceiver 200 is removed and the front-surface cover 300 is detached as illustrated in FIG. 8, the user inserts the optical transceiver 200 into the port 101 of the optical transmission apparatus 100 (S101). As a result, the state becomes a state where the optical transceiver 200 is inserted and the front-surface cover 300 is detached as illustrated in FIG. 19. The terminal unit 110 and the terminal unit 210 are connected, and the terminals are electrically connected to each other. Then, since the insertion/removal detection lines 111 and 211 are short-circuited, the insertion/removal detection circuit 120 of the optical transmission apparatus 100 detects the insertion of the optical transceiver 200 (S102). For example, as illustrated in FIG. 18, once the insertion of the optical transceiver 200 starts at T1, the insertion/removal detection line 111 starts to rise from an off-state at T2, the insertion/removal detection line 111 is turned on at T3 after a chattering period, and the insertion/removal detection circuit 120 detects the insertion of the optical transceiver 200. At this time, the insertion/removal detection circuit 120 does not notify the controller 140 of the detection of the insertion.

After the optical transceiver 200 is inserted, the user covers the front surface of the optical transceiver 200 with the front-surface cover 300 (S103). As illustrated in FIG. 18, the start of attachment of the front-surface cover 300 becomes possible at the same time as or after the start of insertion (e.g., T1) of the optical transceiver 200. Subsequently, the user inserts the screw 310a (first screw) into the screw hole 150a (S104). As a result, the lever switch 160a (first lever switch) is turned on, and the insertion/removal detection circuit 120 detects the insertion of the screw 310a (first screw) via the lever switch detection line 116a (S105). As illustrated in FIG. 18, the start of insertion of the screw 310a (first screw) becomes possible at the same time as or after the start of attachment (e.g., T1) of the front-surface cover 300. Note that either the screw 310a (first screw) or the screw 310b (second screw) may be inserted first. For example, as illustrated in FIG. 18, once the insertion of the screw 310a (first screw) is started at T4, at T5 when the screw 310a has reached the operating point of the lever switch 160a (first lever switch), the output (lever switch detection line 116a) of the lever switch 160a starts to rise from the off-state, the output of the lever switch 160a is turned on at T6 after the chattering period, and the insertion/removal detection circuit 120 detects the insertion of the screw 310a. At this time, the insertion/removal detection circuit 120 does not notify the controller 140 of the detection of the insertion.

Subsequently, the user inserts the screw 310b (second screw) into the screw hole 150b (S106). As a result, the state becomes a state where the optical transceiver 200 is inserted and the front-surface cover 300 is attached as illustrated in FIG. 9. Then, the lever switch 160b (second lever switch) is turned on, and the insertion/removal detection circuit 120 detects the insertion of the screw 310b (second screw) via the lever switch detection line 116b (S107). As illustrated in FIG. 18, the start of insertion of the screw 310b (second screw) becomes possible at the same time as or after the start of attachment (e.g., T1) of the front-surface cover 300. For example, as illustrated in FIG. 18, once the insertion of the screw 310b (second screw) is started at T7, at T8 when the screw 310b reaches the operating point of the lever switch 160b (second lever switch), the output (lever switch detection line 116b) of the lever switch 160b starts to rise from the off-state, the output of the lever switch 160b is turned on at T9 after the chattering period, and the insertion/removal detection circuit 120 detects the insertion of the screw 310b.

Subsequently, since the insertion has been detected in all of the insertion/removal detection line 111 and the two lever switch detection lines 116, the insertion/removal detection circuit 120 notifies the controller 140 of the detection of the insertion (S108). For example, as illustrated in FIG. 18, since the output of the lever switch 160b (second lever switch) is turned on at T9 and all the detection results indicate on-states, the insertion/removal detection circuit 120 switches the state of the detection line 114 from removal to insertion. The order in which the detection results of the insertion/removal detection line 111, the lever switch 160a, and the lever switch 160b change from off to on is not limited, and the state of the detection line 114 is turned into insertion at the time all the detection results indicate the on-state. Note that the front-surface cover 300 becomes completely fixed (attached) at the time both the screw 310a (first screw) and the screw 310b (second screw) are completely inserted (e.g., T9). After the state of the detection line 114 becomes the insertion state at T9, the controller 140 performs processing of power supply start, mounting, and monitoring control. That is, in a case where the insertion detection is notified from the insertion/removal detection circuit 120, the controller 140 instructs the power supply circuit 130 to start power supply (S109). In response to the instruction from the controller 140, the power supply circuit 130 starts power supply to the optical transceiver 200 (S110).

Subsequently, in a case where power source is supplied from the optical transmission apparatus 100, the power reception circuit 220 of the optical transceiver 200 starts power supply to the microcontroller 230 or the like (S111). The microcontroller 230 activates autonomously in a case where power source is supplied from the power reception circuit 220 (S112). Thereafter, the controller 140 attempts to communicate with the microcontroller 230, and communication is established (S113). In a case where communication with the microcontroller 230 is established, the controller 140 mounts the optical transceiver 200 on the OS (S114). In addition, the controller 140 initiates monitoring control with the microcontroller 230.

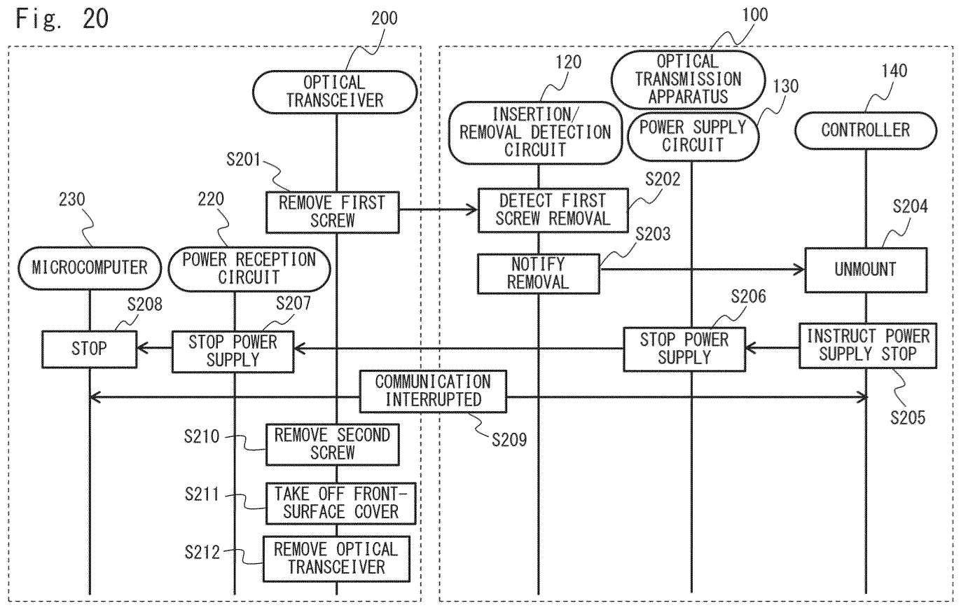

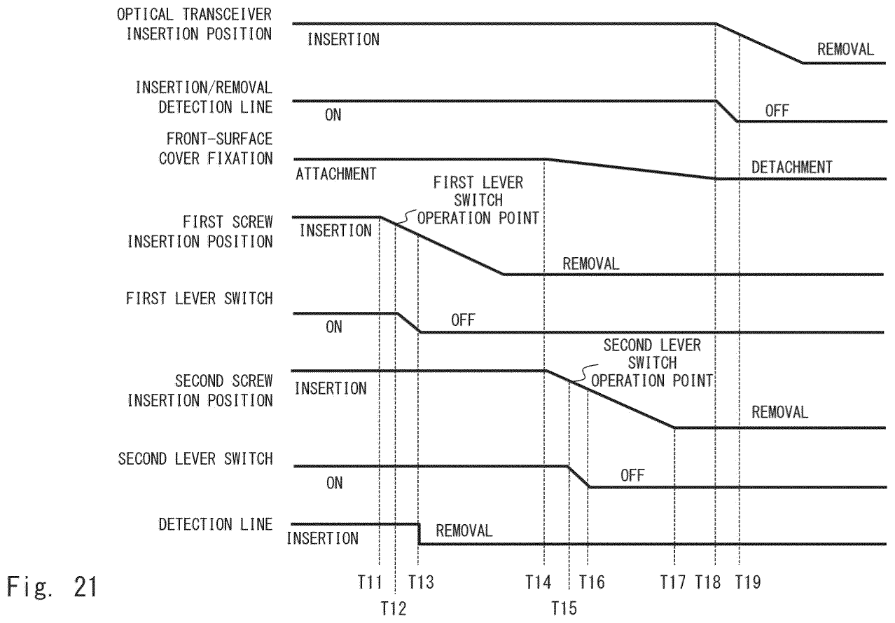

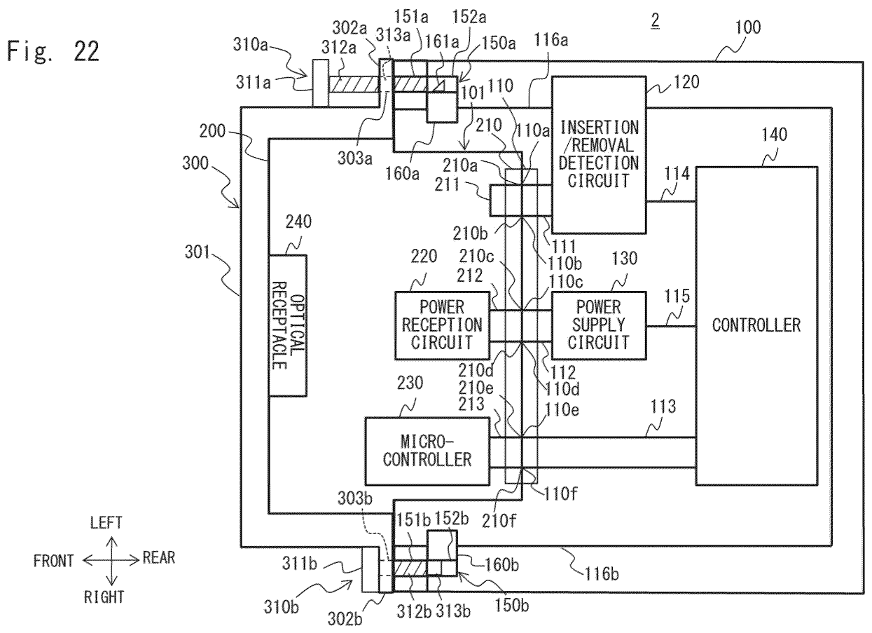

FIG. 20 illustrates an example of a removal procedure in the optical transceiver insertion/removal structure 2 according to some example embodiments. FIG. 21 is a time chart illustrating an operation example associated with S201 to S202 and S210 to S212 in FIG. 20. FIG. 22 illustrates a state where the optical transceiver 200 is inserted and the front-surface cover 300 is attached, and the screw 310a is removed. The removal procedure of FIGS. 20 and 21 are described with reference to FIGS. 8, 9, 19 and 22.

In a case where the optical transceiver 200 is to be removed from a state where the optical transceiver 200 is inserted and the front-surface cover 300 is attached as illustrated in FIG. 9, the user first removes the screw 310a (first screw) from the screw hole 150a (S201). As a result, the state becomes a state where the optical transceiver 200 is inserted, the front-surface cover 300 is attached, and the screw 310a is removed, as illustrated in FIG. 22. Then, the lever switch 160a (first lever switch) is turned off, and the insertion/removal detection circuit 120 detects removal of the screw 310a via the lever switch detection line 116a (S202). For example, the insertion/removal detection circuit 120 detects the screw 310a in the process of being removed from the screw hole 150a. Note that either the screw 310a (first screw) or the screw 310b (second screw) may be removed first. For example, as illustrated in FIG. 21, once the removal of the screw 310a (first screw) is started at T11, at T12 when the screw 310a is removed from the operation point of the lever switch 160a (first lever switch), the output (lever switch detection line 116a) of the lever switch 160a starts falling from an on-state, the output of the lever switch 160a is turned off at T13 after the chattering period, and the insertion/removal detection circuit 120 detects the removal of the screw 310a.

Subsequently, since removal in any of the insertion/removal detection line 111 or the two lever switch detection lines 116 has been detected, the insertion/removal detection circuit 120 notifies the controller 140 of detection of removal (S203). In the present example, a process of the screw 310a being removed from the screw hole 150a is detected, and the controller 140 is notified of detection of removal. For example, as illustrated in FIG. 21, since the output of the lever switch 160a (first lever switch) is turned off at T13 and any of the detection result indicates an off-state, the insertion/removal detection circuit 120 switches the state of the detection line 114 from insertion to removal. The order in which the detection results of the insertion/removal detection line 111, the lever switch 160a, and the lever switch 160b change from off to on is not limited, and the state of the detection line 114 is turned into removal at the time any of the detection results indicates an off-state. During the time after the state of the detection line 114 has turned into removal at T13 and before removal of the optical transceiver 200 is started at T18, the controller 140 performs processing of stopping the monitoring control, unmounting, and stopping the power supply. For example, the time from T13 to T18 can be increased depending on the length of the screw 310. In a case where the detection of removal is notified from the insertion/removal detection circuit 120, the controller 140 stops the monitoring control and unmounts the optical transceiver 200 from the OS (S204). The controller 140 may perform unmounting at the time the removal is notified, or may perform unmounting after a predetermined time has elapsed since the removal is notified and the removal state is stabilized.

After the unmounting, the controller 140 instructs the power supply circuit 130 to stop power supply (S205). In response to the instruction from the controller 140, the power supply circuit 130 stops the power supply to the optical transceiver 200 (S206).

Subsequently, in a case where the power supply from the optical transmission apparatus 100 is stopped, the power reception circuit 220 of the optical transceiver 200 stops the power supply to the microcontroller 230 or the like (S207). In a case where the power supply from the power reception circuit 220 is stopped, the microcontroller 230 stops the operation (S208). Thereafter, communication between the controller 140 and the microcontroller 230 is interrupted (S209).

After removing the screw 310a (first screw), the user removes the screw 310b (second screw) from the screw hole 150b (S210). For example, as illustrated in FIG. 21, once the removal of the screw 310b (second screw) is started at T14, at T15 when the screw 310b is removed from the operation point of the lever switch 160b (second lever switch) the output of the lever switch 160b (lever switch detection line 116b) starts falling from an on-state, the output of the lever switch 160b is turned off at T16 after the chattering period, and the insertion/removal detection circuit 120 detects the removal of the screw 310b. Further, the user removes the front-surface cover 300 from the front surface of the optical transceiver 200 (S211). As illustrated in FIG. 21, the start of removal of the front-surface cover 300 becomes possible at the same time as or after the start of removal (e.g., T11) of one of the screw 310a (first screw) and the screw 310b (second screw), or at the same time as or after the start of removal (e.g., T14) of the other screw. Also, the front-surface cover 300 is completely removed at the same time as (e.g., T17) or after the removal of both the screw 310a (first screw) and the screw 310b (second screw) are completed. As a result, the state becomes a state where the optical transceiver 200 is inserted and the front-surface cover 300 is detached as illustrated in FIG. 19. Note that, the insertion/removal detection circuit 120 detects removal of the screw 310b, but does not notify the controller 140. Further, the user removes the optical transceiver 200 (S212). As a result, the state becomes a state where the optical transceiver 200 is removed and the front-surface cover 300 is detached as illustrated in FIG. 8. As illustrated in FIG. 21, the start of removal of the optical transceiver 200 becomes possible after the front-surface cover 300 is completely detached (e.g., T18). For example, as illustrated in FIG. 21, once the removal of the optical transceiver 200 is started at T18, the insertion/removal detection line 111 starts falling from an on-state, the insertion/removal detection line 111 is turned off at T19 after the chattering period, and the insertion/removal detection circuit 120 detects the removal of the optical transceiver 200. Note that, the insertion/removal detection circuit 120 detects removal of the optical transceiver 200, but does not notify the controller 140.

As described above, according to the present example embodiment, the cover covering the front surface of the optical transceiver is fixed by the screws on the left and right of the optical transceiver, and the lever switch is disposed so as to detect the insertion/removal of the left and right screws. In the present example embodiment, the insertion is not notified to the controller unless the left and right screws are completely inserted and the insertion is detected by the left and right lever switches. Therefore, it is possible to prevent a malfunction caused by an oblique insertion.

Further, in the present example embodiment, during removal of any one of the left and right screws, any one of the left and right lever switches detects removal, and the removal is notified to the controller. With use of this notification, the optical transmission apparatus is able to autonomously perform advance preparation for removal without a user's instruction. In the present example embodiment, the optical transceiver cannot be removed unless the left and right screws are removed and the front-surface cover is detached. Therefore, hot-swapping can be avoided. For example, depending on the length of the stroke of the screw, the number of screws, and the like, it is possible to lengthen the time from the lever switch detects removal until the front-surface cover is removed, and it is possible to secure a time for advance preparation.

Therefore, the user can safely insert/remove the optical transceiver merely by the operation of attaching and detaching the front-surface cover and the optical transceiver.

### Modified Example of Second Example Embodiment

In the above-described example, the front-surface cover 300 is independent of the optical transmission apparatus 100 and the optical transceiver 200, but may be integrated with the optical transmission apparatus 100 or the optical transceiver 200. For example, the front-surface cover 300 may be coupled to and integrated with the optical transmission apparatus 100 or the optical transceiver 200 through a hinge. By integrating the front-surface cover 300 with the optical transmission apparatus 100 or the optical transceiver 200, it becomes possible to prevent forgetting to attach the front-surface cover 300.

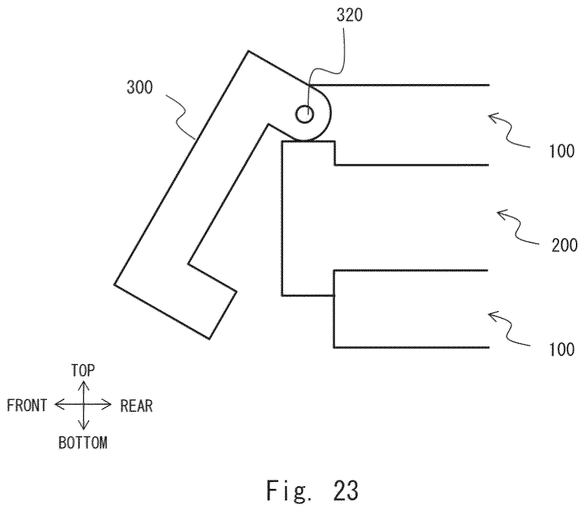

FIG. 23 is a schematic right side view illustrating a configuration example of the front-surface cover 300 according to some example embodiments. In the example of FIG. 23, the front-surface cover 300 is rotatably coupled to the optical transmission apparatus 100 by a hinge 320. For example, in a case where the optical transceiver 200 is to be inserted, first, the front-surface cover 300 coupled to the optical transmission apparatus 100 is lifted upward in such a way that the opening of the port 101 is opened. In this state, the optical transceiver 200 is inserted into the port 101 of the optical transmission apparatus 100. Further, the front-surface cover 300 coupled to the optical transmission apparatus 100 is lowered, in such a way that the front-surface cover 300 covers the front surface of the optical transceiver 200, and the screw 310 is attached as in the above-described example.

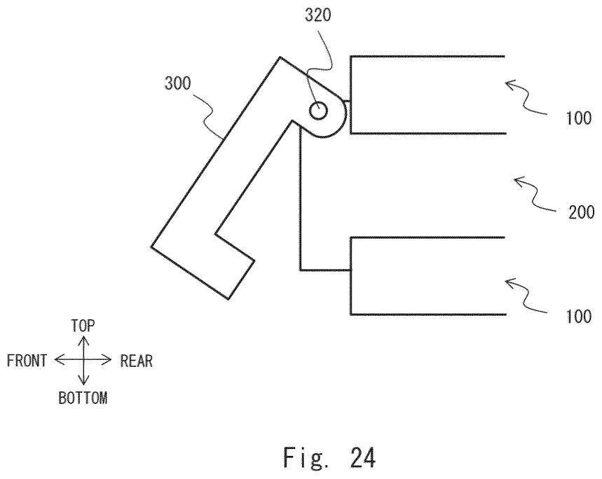

FIG. 24 is a schematic right side view illustrating a configuration example of the front-surface cover according to some example embodiments. In the example of FIG. 24, the front-surface cover 300 is rotatably coupled to the optical transceiver 200 by the hinge 320. For example, in a case where the optical transceiver 200 is to be inserted, the optical transceiver 200 is inserted into the port 101 of the optical transmission apparatus 100 while the front-surface cover 300 coupled to the optical transceiver 200 is lifted. Further, the front-surface cover 300 coupled to the optical transceiver 200 is lowered to cover the front surface of the optical transceiver 200 with the front-surface cover 300, and the screw 310 is attached as in the above-described example.

The present disclosure is not limited to the above-described example embodiments, and can be appropriately modified without departing from the scope of the present disclosure.

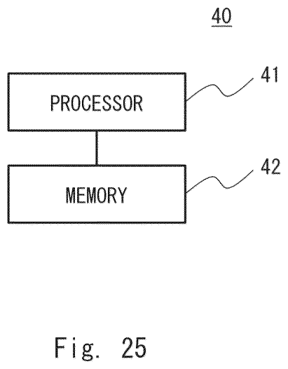

Each configuration in the above-described example embodiment is configured by hardware or software, or both, and may be configured by one piece of hardware or software, or may be configured by a plurality of pieces of hardware or software. Each apparatus such as an optical transmission apparatus or an optical transceiver and each function (processing) may be implemented by a computer 40 having a processor 41 such as a central processing unit (CPU) and a memory 42 as a storage apparatus, as illustrated in FIG. 25. For example, a program for performing the method (control method) according to the example embodiments may be stored in the memory 42, and each function may be implemented by executing the program stored in the memory 42 by the processor 41.

These programs can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure. Each example embodiment can be combined with other example embodiments as appropriate.

Each of the drawings are merely illustrative of one or more example embodiments. Each drawing may be associated with one or more other example embodiments, rather than only one particular example embodiment. As those skilled in the art will understand, various features or steps described with reference to any one of the figures may be combined with features or steps illustrated in one or more other figures, for example, to produce example embodiments that are not explicitly illustrated or described. Not all of the features or steps illustrated in any one of the figures to describe the example embodiments are necessarily essential, and some features or steps may be omitted. The order of the steps described in any of the figures may be changed as appropriate.

Some or all of the above-described example embodiments may be described as the following supplementary notes, but are not limited thereto.

### Supplementary Note 1

An insertion/removal structure including:
an optical transmission apparatus;
an optical transceiver configured to be insertable/removable into/from a port of the optical transmission apparatus; and
a cover configured to cover a portion, being exposed from the port, of the optical transceiver inserted into the port,
wherein the cover covering the optical transceiver is detachably fixed to an attachment unit of the optical transmission apparatus by a fixing member.

### Supplementary Note 2

The insertion/removal structure according to supplementary note 1, wherein the optical transmission apparatus includes:
a detection unit configured to detect that detachment of the fixing member from the attachment unit starts; and
a control unit configured to execute necessary processing before removal of the optical transceiver, based on a result of the detection.

### Supplementary Note 3

The insertion/removal structure according to supplementary note 2, wherein
the fixing member can be inserted into the attachment unit, and
the detection unit detects that the fixing member is in a process of being removed from the attachment unit.

### Supplementary Note 4

The insertion/removal structure according to supplementary note 3, wherein
the fixing member is a screw,
the attachment unit is a screw hole into which the screw is inserted, and
the detection unit is a switch configured to detect presence or absence of a tip portion of the screw at a bottom portion of the screw hole.

### Supplementary Note 5

The insertion/removal structure according to any one of supplementary notes 1 to 4, wherein the fixing member includes a first fixing member and a second fixing member that are configured to fix the cover at an outer peripheral portion of an opening of the port.

### Supplementary Note 6

The insertion/removal structure according to supplementary note 5, wherein
the port includes a plurality of terminals to be electrically connected, and
the first fixing member and the second fixing member fix the cover on both sides of the outer peripheral portion of the opening of the port in a direction in which the plurality of terminals in the port are arranged.

### Supplementary Note 7

An insertion/removal method including:
inserting an insertable/removable optical transceiver into a port of an optical transmission apparatus;
covering a portion, being exposed from the port, of the optical transceiver inserted into the port with a cover; and
detachably fixing, by a fixing member, the cover covering the optical transceiver to the optical transmission apparatus.

### Supplementary Note 8

An optical transmission apparatus including:
a port into/from which an optical transceiver can be inserted/removed;
an attachment unit configured to detachably fix, by a fixing member, a cover covering a portion, being exposed from the port, of an optical transceiver inserted into the port;
a detection unit configured to detect that detachment of the fixing member from the attachment unit starts; and
a control unit configured to execute necessary processing before removal of the optical transceiver, based on a result of the detection.

### Supplementary Note 9

A control method including:
in a case where a cover covering a portion, being exposed from a port of an optical transmission apparatus, of an optical transceiver inserted into the port is detachably fixed to an attachment unit of the optical transmission apparatus by a fixing member, detecting that detachment of the fixing member from the attachment unit starts; and
executing necessary processing before removal of the optical transceiver, based on a result of the detection.

### Supplementary Note 10

A control program configured to cause a computer to execute processing of:
in a case where a cover covering a portion, being exposed from a port of an optical transmission apparatus, of an optical transceiver inserted into the port is detachably fixed to an attachment unit of the optical transmission apparatus by a fixing member, detecting that detachment of the fixing member from the attachment unit starts; and
executing necessary processing before removal of the optical transceiver, based on a result of the detection.

Some or all of the elements (e.g., configurations and functions) described in Supplementary notes 2 to 6 depending on Supplementary note 1 (insertion/removal structure) may be dependent on Supplementary notes 7 (insertion/removal method), 8 (optical transmission apparatus), 9 (control method), and 10 (control program) in dependencies similar to those described in Supplementary notes 2 to 6. Some or all of the elements described in any supplementary note may be applied to various types of hardware, software, recording means for recording software, systems, and methods.

What is claimed is:

1. An insertion/removal structure comprising:
an optical transmission apparatus;
an optical transceiver configured to be insertable/removable into/from a port of the optical transmission apparatus; and
a cover configured to cover a portion, being exposed from the port, of the optical transceiver inserted into the port,
wherein the cover covering the optical transceiver is detachably fixed to an attachment mechanism of the optical transmission apparatus by a fixing member.

2. The insertion/removal structure according to claim 1, wherein the optical transmission apparatus includes:
a detector configured to detect that detachment of the fixing member from the attachment mechanism starts; and
a controller configured to execute necessary processing before removal of the optical transceiver, based on a result of the detection.

3. The insertion/removal structure according to claim 2, wherein
the fixing member can be inserted into the attachment mechanism, and
the detector detects that the fixing member is in a process of being removed from the attachment mechanism.

4. The insertion/removal structure according to claim 3, wherein
the fixing member is a screw,
the attachment mechanism is a screw hole into which the screw is inserted, and
the detector is a switch configured to detect presence or absence of a tip portion of the screw at a bottom portion of the screw hole.

5. The insertion/removal structure according to claim 1, wherein the fixing member includes a first fixing member and a second fixing member that are configured to fix the cover at an outer peripheral portion of an opening of the port.

6. The insertion/removal structure according to claim 5, wherein
the port includes a plurality of terminals to be electrically connected, and
the first fixing member and the second fixing member fix the cover on both sides of the outer peripheral portion of the opening of the port in a direction in which the plurality of terminals in the port are arranged.

7. An optical transmission apparatus comprising:
a port into/from which an optical transceiver can be inserted/removed;
an attachment mechanism configured to detachably fix, by a fixing member, a cover covering a portion, being exposed from the port, of an optical transceiver inserted into the port;
a detector configured to detect that detachment of the fixing member from the attachment mechanism starts; and
a controller configured to execute necessary processing before removal of the optical transceiver, based on a result of the detection.

8. A control method including:
in a case where a cover covering a portion, being exposed from a port of an optical transmission apparatus, of an optical transceiver inserted into the port is detachably fixed to an attachment unit of the optical transmission apparatus by a fixing member, detecting that detachment of the fixing member from the attachment unit starts; and
executing necessary processing before removal of the optical transceiver, based on a result of the detection.
